(19) United States
(12) Patent Application Publication
(10) Pub. No.: US 2020/0340590 A1
(43) Pub. Date: Oct. 29, 2020

(54) BUTTERFLY VALVE COMPRISING AN ACTUATED SEAL

(71) Applicant: Peter John WOODWARD, Southampton Hampshire (GB)

(72) Inventor: Peter John WOODWARD, Southampton (GB)

(21) Appl. No.: 16/963,028

(22) PCT Filed: Jan. 17, 2019
(86) PCT No.: PCT/GB2019/050132

§ 371 Date: Jul. 17, 2020

(30) Foreign Application Priority Data
Jan. 19, 2018 (GB) 1800928.2

(51) Int. Cl. F16K 1/226; F16K 1/228

(52) U.S. Cl. CPC F16K 1/2261; F16J 15/46; F16K 1/228

(57) ABSTRACT

A butterfly valve comprising a valve body and a rotatable obturator (3), the rotatable obturator mounted in the valve body for rotation about an axis, arranged to be rotated between a closed condition and an open condition, the rotatable obturator comprising an actuated seal (5) which is arranged to seal against a sealing surface (12a) of the valve body, and the actuated seal comprising a rearward surface (5e) arranged to be acted on by a pressurised fluid, and the seal mounted in the obturator for displacement outwardly from the obturator as the result of application of the pressurised fluid so as to seal against the sealing surface of the valve body in a substantially fluid-tight manner.

### TECHNICAL FIELD

The present invention relates generally to valves, in particular to a class of valve known as a butterfly valve.

### BACKGROUND

Butterfly valves generally comprise an obturator in the form of a disc which is mounted for rotation about an axis from a closed position to an open condition, and vice versa. The axis of rotation usually passes horizontal of the disc, and rotation may be about a single through shaft or two stub shafts, one stub shaft at each side of the butterfly valve. Vertical shafts are also an admissible axis of rotation for a butterfly valve. Butterfly valves may for example be concentric or double or triple eccentric disc design. An electric actuator and gearbox, or manual gearbox or hydraulic cylinder/lever weight operation is provided to drive the valve from an open condition to a closed condition and vice versa.

Butterfly valves have many applications in many different sectors, and are mainly used to isolate or regulate a flow of fluid or gas. For example, this may be to isolate a pipeline medium and pressure on a discharge/downstream side of valve, where it is desirable to enable the replacement of the normal primary seal in-situ, without draining down the delivery pipeline.

Pipeline operating pressures and valve ratings can vary for each application from as low as 6 bar to say 25 bar or greater as required and could apply to valves typically from DN1200 to DN5000 or greater but not necessarily limited by size.

### SUMMARY

According to the invention there is provided a butterfly valve comprising a valve body and a rotatable obturator, the rotatable obturator mounted in the valve body for rotation about an axis, arranged to be rotated between a closed condition and an open condition,

the obturator comprising an actuated seal which comprises a nose portion which is arranged to seal against a sealing surface of the valve body, and the actuated seal comprising a rearward surface of the nose portion arranged to be acted on by a pressurised fluid,
and the seal mounted in the valve for displacement outwardly from the obturator so as to seal against the sealing surface of the valve body.

The valve body may comprise an internal seating ring, which seat ring provides the sealing surface for the seal. The sealing surface may be described as an inner sealing surface.

The nose portion may comprise a rounded or curved or ribbed cross-sectional geometry or profile. The (one or more (spaced apart)) ribs or peaks may extend around the seal nose.

The nose portion may be of solid or substantially non-hollow construction. The seal nose may be non-inflatable.

The nose portion may be formed of a resilient material, such as silicone or rubber.

The nose portion may have a resilience which allows the same to at least in part conform to the profile of the sealing surface of the sealing ring of the valve body when the seal is actuated.

The seal may comprise an inflatable chamber, which, when provided with pressurised fluid, urges a nose of the actuated seal, into sealing engagement with the sealing surface. The extent of inflation/expansion is constrained by adjacent wall portions of the obturator (or components attached to the obturator) which define the space in which the chamber is located.

The seal may be viewed as having a forward nose portion and a rearward inflatable/expandable chamber.

The seal may be of substantially annular or substantially ring form, but could be rectangular or square in shape if isolating a penstock or ducting.

The seal may be the sole or principal seal of the valve, for example for applications of critical isolation or where temperature extremes would cause an issue of thermal expansion/contraction if valve metal seats were employed. Low operating valve torque and reduced actuation cost and low seal wear factors are additional considerations. Alternatively, the seal may be a secondary seal, and the valve comprising a further seal. The further seal may be the primary seal, whereas the actuated seal is secondary seal, for example for use when maintenance or replacement of the primary seal is required. The primary seal may be a conventional butterfly valve seal, which is fixedly secured in position (i.e. is not displaceable by a pressurized fluid like the secondary seal).

The valve may comprise a shaft portion, which defines an axis or rotation about which the obturator is rotatable. The shaft portion may be provided with a pressurised fluid conduit or line, which extends from an externally accessible entry point of the shaft, which may be a distal end of the shaft portion.

The fluid pressurisation system may comprise a hydraulic or a pneumatic (e.g. compressed air) system for actuating the actuated seal.

A pressurised fluid line or conduit may be provided through a shaft portion of the butterfly valve. The conduit or line may comprise an inlet which is connected to a pressurised fluid source at a distal end of the shaft portion.

The invention may comprise one or more features described in the description and/or as shown in the drawings, either individually or in combination.

### BRIEF DESCRIPTION OF THE DRAWINGS

Various embodiments of the invention will now be described, by way of example only, with reference to the following drawings in which:

FIG. 1 shows a front elevation of a butterfly valve (in a closed condition),

FIG. 2 is a cross-section of the butterfly valve of FIG. 1 which shows the arrangement of the sealing between the valve and the valve body, and,

FIG. 3 is an enlarged cross-sectional view of part of FIG. 2, which shows various components and sub-assemblies in more detail.

### DETAILED DESCRIPTION

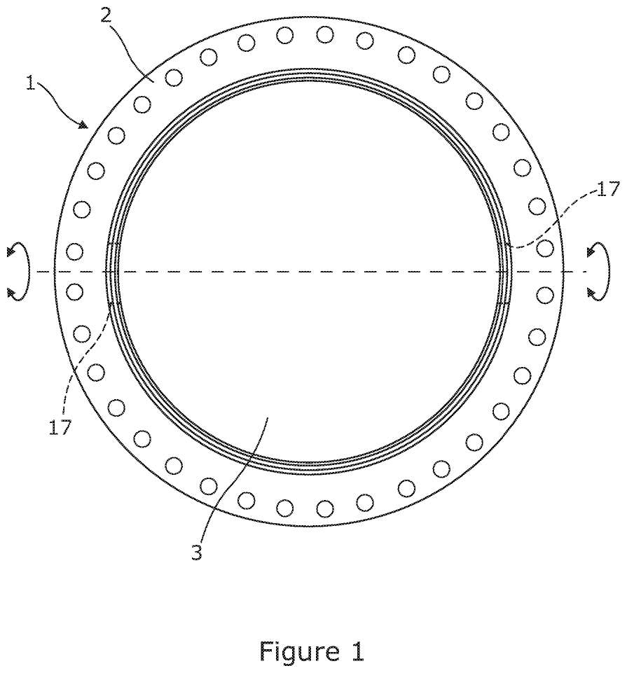

Reference is made initially to FIG. 1 which shows a butterfly valve 1, which comprises a valve body 2 comprises and a rotatable obturator disc 3. The butterfly valve 1 is suitable for use in control or isolation of the flow of fluid in pipework in which the valve is installed. The valve can be set to an open condition in which fluid is allowed to flow through the valve, and a closed condition in which fluid is prevented from flowing through the valve. As will be described in detail below, the seal is actuated by way of the application of pressurised fluid.

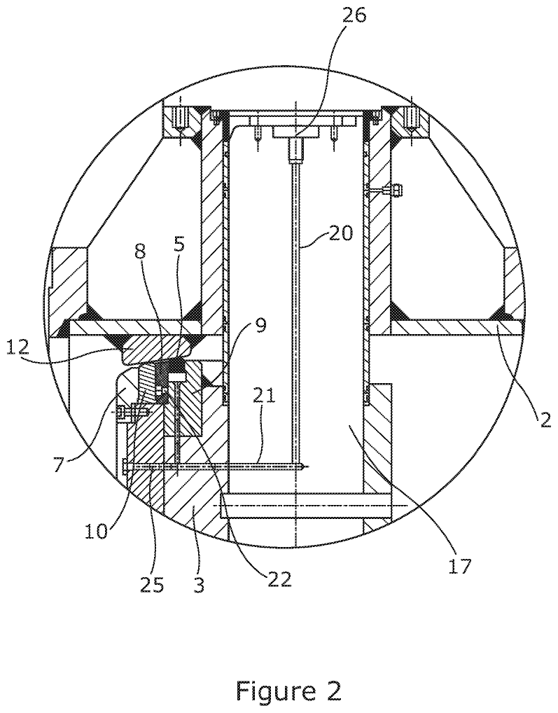

The valve disc 3 is rotatably mounted to the body 2 by way of horizontal stub shafts 17 each side of the valve, or alternatively vertical upper and a lower stub shafts, which are axially aligned, of which one stub shaft 17 is shown in FIG. 2, so as to enable rotation of the valve about the axis. Alternatively, a single through shaft can be provided.

The valve disc 3 is provided with a normal service seal 10 and an actuated seal 5. Both seals are of annular or ring shape, and are provided adjacent to a circumferential outer region of the valve disc 3. Each of the seals 5 and 10 is arranged in use to bear against a sealing surface 12a of a seat ring 12 of the body 2. The seal 10 (which may be termed the service seal) is the seal which is normally in use, whereas the seal 5 is selectively actuated to effect a seal when the service seal is non-operational, e.g. for repair, replacement or servicing requirements of the service seal without the need to drain down the delivery pipeline.

The service seal 10 is held in place by way of a first (removable) and adjustable tension retaining ring 7 and a second seal fixed position retaining ring 8, both seals by way of a clamping action.

The actuated seal 5 is laterally located also by a clamping action, which comes about as a result of the second seal retaining ring 8, and a portion 9 of the carcass of the valve disc 3.

The seal 5 can be designed and manufactured to safely handle high levels of actuation pressure according to the particular pipeline pressure to be isolated, and achieve valve seat tightness in contact with the surface 2a, without failure, extrusion or rupture.

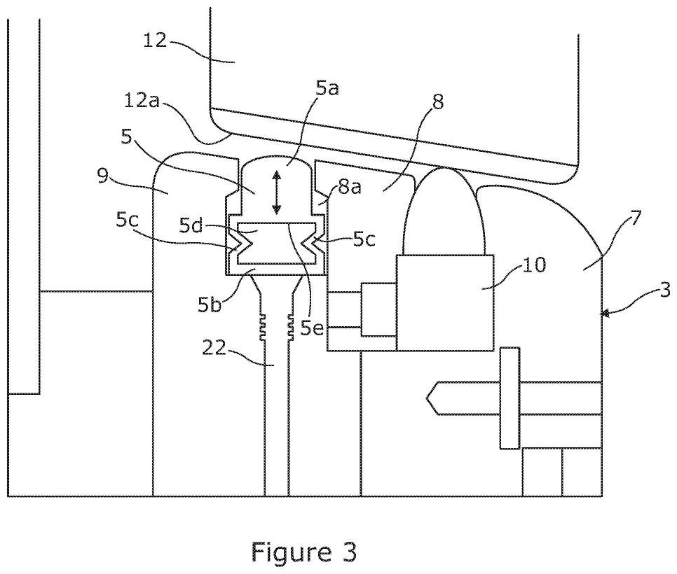

The seal 5 comprises a rounded solid nose 5a which is arranged to be brought into contact with the surface 12a of the seat ring 12. As best seen in FIG. 3, a rearward part of the seal 5 comprises two opposing bellow-type walls 5c, which together with the basal wall 5b define an internal space 5d. The internal space 5d has an opening which is connected to the supply of pressurised fluid via the conduit 22. In use, a degree of flexure of the walls 5c is permitted, in the direction of displacement of the seal nose 5. The bellowed walls 5c adopt a compact condition when pressurised fluid is not applied. The walls 5c may be considered as having ‘live’ hinge portions which in an unbiased condition adopt a contracted condition.

The seal 5 is constrained in a space defined by the walls of the second retaining ring 8 and the portion 9 of the valve disc 3. For each, a shoulder 8a and 9a is respectively provided, which effects a transition from a wider channel to a narrow channel. This configuration ensures retention of the seal 5 with the valve disc, with the seal 5 being seen to have a complementary retaining T-shape. The geometry of these seal retaining elements such as to create a substantially T shape anti-pull-out or withdrawal retention of the seal 5 when viewed in cross section. The service seal 10 is held in position adjacent to the seal 5 by a respective retention ring having a similar T-shape (when viewed in cross section) as that for the seal 5. It will be appreciated that other suitable securing geometry could be used.

Advantageously, because the actuated seal 5 has a solid seal nose, which is displaced forwardly towards the sealing surface 12a when the pressurised fluid is applied, no extrusion or rupture risks arise, which could compromise the sealing ability of the seal. Furthermore, there are no seal wall erosion and seal wall thinning issues since the substantially thick section and resilience of the seal nose absorbs any long-term irregularities and in the deactivated state the seal 5 nose retracts below flush to the disc edge with no protrusion in the flow stream limiting exposure to abrasive flow medium conditions. It will be appreciated that when the chamber is provided with pressurised fluid to expand, this involves substantially no stretching of the material of the walls per se, for example as in the case of a balloon being inflated. Rather the constraining function of the space in which the seal 5 is located and retained, prevents any such inflation (which stretches the material of the walls).

Actuation of the seal 5 when the valve disc 3 is in a partially open position (i.e. non-fully closed) to the body 2 is prevented by the fluid pressurisation system only capable of applying a pressurised fluid to the seal 5 when the valve disc 5 is in the fully closed position. This may include a sensor to determine whether the valve disc is in the fully shut position and system interlocks before any pressurised fluid is applied.

Once the valve disc 3 is fully shut allowing seal actuation, the circumferential outer region of the valve disc is in position facing the sealing surface 12a. In this condition the seal 5 is completely supported or corseted by (a) (steel) retaining ring 8, and (b) valve (steel) disc 9, and (c) the (steel) sealing surface 12a, and protected against being over-pressurization or over-inflation which carries the associated risk of seal rupture or extrusion, since the seal is retained by and its movement restricted by the surrounding metal (except for the translational movement required to effect the seal contact with the sealing surface 12a). Therefore, when the pressurising fluid is applied to actuate the seal 5, the strength of the seal affected is in relation to the surrounding and supporting steel of valve disc, seal retaining ring, valve body seat ring and highly secure.

The cross-section and geometry of the seal 5 is such as to facilitate seal flexure and movement to make good compressive contact of the sealing face to effect a seat tight closure. The seal 5 itself does not actually expand when actuated, rather pressurisation fluid causes movement of the concertina flexible walls 5c to straighten from their contracted condition, allowing the solid section seal nose 5a to move forward into contact with the surface 2a with sufficient force as to make a compression leak-tight seal. Therefore no seal actuation pressure is wasted and maximum efficiency is obtained from the seal energising pressure concentrated on sealing closure and maximising effective performance without unnecessarily higher inflation pressures wasted and shared between seal inflation and seal wall 5c expansion, as would be the case in a seal design where the seal nose itself has a pressurised cavity with thinner walls prone to the outer corner regions of the seal 5 being extruded or distorted as the internal pressure is raised to effect a seal, thus resulting in a potential loss of sealing force.

The internal pressure in the cavity 5d as applied to rearward surface 5e has a direct bearing on the actual seal to surface 12a contact compression to seal in a very effective manner since the area of said wall 5e to which the pressurised fluid is applied is greater than the area of the solid nose 5a with no sealing force dissipation. Put in other terms, the inner seal inflation surface area on which the internal seal inflation pressure is acting is a greater surface area than the outer sealing nose of the seal on which the pipeline pressure is acting against which we must create a tight seal, which allows a differential in surface area and greater sealing force for a given internal seal pressure to seal tight against the pipeline pressure.

In use, when the pressurised fluid is applied, fluid within the cavity 5d causes the seal 5 to be deployed. For the purpose of illustration, FIG. 3 shows the seal 5a in a non-operational condition, in which the walls 5c and the space 5d are in a contracted (‘angled’) condition. Whereas, FIG. 2 shows the seal, in a deployed condition, which the walls 5c straightened and the space 5d expanded, and the seal nose 5a urged against the sealing surface 12a.

When the seal 5 is de-energised, and the application of the pressurised fluid is disabled, the actuated seal 3 is arranged to relax/retract into the respective cavity provided in valve 3 which retraction is assisted by the pipeline pressure acting on the outer periphery of the actuated and the seal. This is brought about by the concertina/expansible walls 5c. These have an ‘internal memory’ to cause the seal 5 to revert to its retracted contracted form. The de-energised seal returns to its original non-protrusion position flush to or behind the outer surface of the valve disc. The walls 5c combined with pipeline pressure causes the seal 5 to pull back to its original state position.

Since the point at which the pressurized fluid is injected is at a rearward surface 5b of the seal 5 this avoids avoid blow out or rupture risk under high injection pressure.

The seal 5 may be formed by an extrusion process, or a moulding process, with a heat sealed joint to connect the ends to complete the circular or other shape of the seal. The seal ends jointing technique follows established market technology for a high integrity secure joint. The seal may be formed of silicon or other type of rubber.

The seal 5 is positioned on the valve (disc) in series with the normal service seal 10. However, in other embodiments, the actuated seal may be the sole (service) seal of a butterfly valve, as opposed to being a secondary seal for use in maintenance procedures or routines. The seal 5 is mounted on the same side of the disc as the service seal 10, and is held in place by a retaining ring connected to the valve disc, by way of a clamping action. It will be appreciated that where the valve comprises a two plate disc (for example two places, the spatial relationship of which is maintained by an intermediate rigid structure, such as ribs).

The admission of air or hydraulic inflatable pressure from controlled external source (not illustrated) is achieved by routing the seal inflation pressure through one of the stub shafts (or equally through a single shaft, where such is provided in place of two stub shafts) to a point where the stub shaft has crossed the water way between valve body and disc with shaft entry. The stub shaft is provided with quick connect coupling 26 to allow easy connection to the external source, for example by way of a hose with a connector. Conduits 20 (passing through the shaft 7) and 21 (passing through the shaft and the valve disc) connect the pressurised fluid flow to the seal 5.

Where, as in the illustrated example, the valve is a disc of two spaced-apart seals and their respective retaining rings, providing both service seal 10 and the actuated seal 5 on the same disc main plate designed of substantial thickness and rigidity means that it is advantageously capable of withstanding forces which would otherwise cause flexure/distortion with upset sealing and thereby maintaining the most effective sealing contact between the valve and the valve body. Arranging both service seal and maintenance seal on the same main single disc has the distinct advantage over an alternative double disc design where to accommodate two seals, both discs are necessarily of similar heavy rigid construction in order to achieve each seal tight sealing performance, irrespective of the maintenance seal design configuration or whether of a resilient or metal seal type.

The consequent disadvantage of a double disc design to separately accommodate two seals is (a) disc higher cost (b) greater disc weight with additional frictional loads and wear on shaft bearings (c) increased operating torque (d) occupies more space with greater obstruction to valve flow passage and increased head loss or reduced flow, compared with a single disc valve.

As described above, when the actuated seal is in its non-operative condition it sits wholly within the space provided by the valve, and does not protrude outwardly beyond flush of the spatial envelope of the valve. In this way, erosion damage is avoided during in normal valve operation and opening and closing velocities. This is not the case with other mechanically operated secondary seals where by design the seal fully exposed in the water way with often erosive silt flow medium conditions.

The actuated seal is advantageously not susceptible to long term silt and hardening deposits which could render the seal inoperable over the long-term, for example as is the case and risk of employing either resilient or metal mechanically operated seals.

1. A butterfly valve comprising a valve body and a rotatable obturator, the rotatable obturator mounted in the valve body for rotation about an axis, arranged to be rotated between a closed condition and an open condition, the rotatable obturator comprising an actuated seal which is arranged to seal against a sealing surface of the valve body, and the actuated seal comprising a rearward surface arranged to be acted on by a pressurized fluid,
and the seal mounted in the obturator for displacement outwardly from the obturator as the result of application of the pressurized fluid so as to seal against the sealing surface of the valve body in a substantially fluid-tight manner, wherein the seal comprises a nose portion, arranged to seal against the valve body, which is formed of a substantially solid section resilient material, and further wherein the rotatable obturator comprises a cavity which is arranged to captively retain the seal, whilst allowing for displacement to and from a deployed condition, and the obturator also comprises a further seal, which is spaced apart from the actuated seal, and which further seal is fixedly secured in position.

2. A butterfly valve as claimed in claim 1 in which a pressurized fluid line or conduit is provided through a shaft portion of the butterfly valve and part of the obturator so as to supply a pressurized fluid to the actuated seal.

3. A butterfly valve as claimed in claim 2 in which an inlet to the pressurizing fluid line or conduit is provided at a distal end of a shaft portion the rotatable obturator, which is connected to the shaft for rotation thereof.

4. A butterfly valve as claimed in claim 1 in which rearward walls of the seal are arranged to be expansible from a contracted condition to an expanded condition on application of actuating pressurized fluid.

5. A butterfly valve as claimed in claim 1 in which a rearward part of the seal comprises a chamber which is arranged to be filled with pressurizing fluid.

6. A butterfly valve as claimed in claim 1 in which the actuated seal is substantially t-shape when viewed in cross-section.

7. A butterfly valve as claimed in claim 1 in which the cavity has a widened portion and a narrowed portion to captively retain the seal.

8. A butterfly valve as claimed in claim 1 in which in a non-operational condition, the actuated seal is located below or flush with the obturator edge profile.

9. A butterfly valve as claimed in claim 1 in which the actuated seal comprises wall portions which define a pressurized fluid chamber, and the walls arranged to adopt a contracted condition or an extended condition.

10. A butterfly valve as claimed in claim 1 in which the obturator (or components of or connected to the obturator) comprises surface portions which define a space in which the actuated seal is constrained and retained, but which allows for movement to an operational condition.

11. A butterfly valve comprising a valve body and a rotatable obturator, the rotatable obturator mounted in the valve body for rotation about an axis, arranged to be rotated between a closed condition and an open condition,
the rotatable obturator comprising an actuated seal which is arranged to seal against a sealing surface of the valve body, and the actuated seal comprising a rearward surface arranged to be acted on by a pressurized fluid,
and the seal mounted in the obturator for displacement outwardly from the obturator as the result of application of the pressurized fluid so as to seal against the sealing surface of the valve body in a substantially fluid-tight manner, and wherein the actuated seal comprises wall portions which define a pressurized fluid chamber, and the walls arranged to adopt a contracted condition or an extended condition.
